(19) United States
(12) Patent Application Publication
(10) Pub. No.: US 2026/0327012 A1
(43) Pub. Date: Oct. 22, 2026

(54) CONVEYING SYSTEM AND METHOD

(71) Applicant: SAIA-BURGESS LLC, VANDALIA, OH (US)

(72) Inventors: Adam W. STIENECKER, Tipp City, OH (US); Doug VORHEES, Centerville, OH (US)

(21) Appl. No.: 19/693,100

(22) Filed: May 29, 2026

Related U.S. Application Data
(63) Continuation of application No. PCT/US2025/010715, filed on Jan. 8, 2025.

(51) Int. Cl. B65G 13/10; B65G 13/06

(52) U.S. Cl. CPC B65G 13/10; B65G 13/065; B65G 2203/0258; B65G 2203/0283

(57) ABSTRACT

A conveying system having mechanically independent steerable wheel movers and a method of operating the system are disclosed. The method can include directing at least one motor of a steerable wheel mover, with a mover controller, to rotate a wheel of the mover about a wheel axis of rotation at a rotational velocity or to rotate the wheel to a first angular orientation about a steer angle axis. The method can also include detecting a change in at least one operating parameter of the mover after the directing other than the change to the directed rotational velocity of the wheel or to the directed angular orientation of the wheel. The method can also include determining, with a master controller of the conveying system, at least a portion of the mass of a package positioned at least in part on the mover based at least in part on the change detected during the detecting.

### CROSS REFERENCE TO RELATED APPLICATIONS

This non-provisional patent application is a continuation application of PCT Application No. PCT/US2025/010715, filed with the USPTO on Jan. 8, 2025, which is incorporated herein by reference in its entirety.

### FIELD OF THE INVENTION

The present disclosure relates to power-driven conveyors for moving a load over a predetermined path or path section and configured to vary the operating modes of different portions of the one conveyor.

### BACKGROUND

U.S. Pat. No. 7,040,478 discloses a STEERABLE DIVERTER SYSTEM. The diverter system is for diverting articles being conveyed along the diverter system includes a plurality of diverter wheels arranged between opposite sidewalls of the diverter system. The diverter wheels are rotatably driven by a motorized roller and a plurality of drive members or bands reeved around the motorized roller and respective ones of the diverter wheels. The diverter wheels are steerable in response to pivotal or rotational movement of a drive gear that engages a gear plate of at least one of the wheels. The resulting pivotal movement of the at least one wheel causes a translational movement of a rack member extending along the row of diverter wheels which, in turn, causes a corresponding pivotal movement of the other wheels engaged with the rack member.

U.S. Pat. No. 9,505,560 discloses a SYSTEM AND METHOD FOR CONTROLLING A MOVING ELEMENT IN A LINEAR MOTOR CONVEYOR. The system for controlling moving elements includes a zone controller; a first network and a second network; at least one first motor gateway associated with a portion of the conveyor and assigned to the first network; and at least one second motor gateway associated with a different portion of the conveyor and assigned to the second network; wherein the zone controller and the motor gateways are configured to: communicate data to control the moving elements via the first and second networks in a structured manner to compensate for network or processing timing. A method for controlling moving elements including communicating data related to control of the moving element conveyor, in a structured manner to compensate for network or processing timing, between a zone controller and first and second motor gateways.

U.S. Pat. No. 9,745,143 discloses a PITCH INDEPENDENT DIVERT DRIVE. The diverting conveyor has an array of transmissions having powered output rollers that form a conveying surface for selectively diverting articles from a first direction to a second direction. Each transmission has a timing belt pulley to operably engage with a toothed timing belt, and each is configured to simultaneously rotate the output roller from the first direction to the second direction in response to actuation of an actuator. When the timing belt pulley engages with the teeth of the timing belt, the output roller of an actuator is rotated around an axis perpendicular to the conveying surface to a rotational position that is a multiple of the tooth spacing of the timing belt. Each output roller has a driven direction resulting from the engagement of the timing belt with the timing belt pulley. An adjuster is provided to align the driven directions of the array of output rollers.

U.S. Pat. No. 10,810,534 discloses SYSTEMS AND METHODS FOR SORTATION OF PRODUCTS USING A CONVEYOR ASSEMBLY. In some embodiments, apparatuses and methods are provided useful to the sortation of products using a conveyor assembly. In some embodiments, there is provided a system for receiving and sorting products shipped to a shopping facility including: a delivery location at a shopping facility configured to receive a shipment of products; a conveyor assembly comprising: a product identification module configured to read identification data from an identification label disposed on a product; a plurality of sortation modules configured to move the product to one of a predetermined plurality of sortation destination areas; a control circuit operatively coupled to the product identification module and to each of the sortation modules, the control circuit configured to: receive the identification data from the product identification module; determine the sortation destination area for the product based at least on one of shopping facility data and shipping data regarding the product as sortation criteria; and cooperate with the plurality of sortation modules to move the product to the determined sortation destination area.

U.S. Pat. No. 11,358,803 discloses a CONTROL UNIT FOR A CONVEYOR WITH HARDWARE DETECTION. A method for configuring a control unit in a conveyor, wherein a control unit controls one or more conveyor segments comprising a conveyor drive in signal communication with the control unit via a motor connection socket, and a sensor for detecting an object at a position within the conveyor segment. The conveyor is in signal communication with the control unit via a sensor connection socket. The control unit self-configures itself by: (i) activating a configuration mode in the control unit, (ii) receiving a signal from each motor connection socket or sensor connection socket, (iii) comparing the received signal(s) with a comparative value stored in the control unit, and (iv) determining whether a conveyor drive or a sensor is connected to a motor connection socket or a sensor connection socket of the control unit, respectively, based on the comparison of the signal(s) with the comparative value.

U.S. Pat. No. 11,599,101 discloses an INDEPENDENT MOVER TRANSPORT SYSTEM AND METHOD OF EXTENDING RANGE OF OPERATIONS IN AN INDEPENDENT MOVER TRANSPORT SYSTEM. The system comprises a mover having an axis, and a track. The track includes first and second track segments, and a controller operative to drive a first coil of the first track segment to control movement of the mover along the first track segment towards the second track segment. The controller is further operative to define a first zone for the first track segment, define a second zone for the first track segment, drive the first coil to control movement of the mover with the first set of controller gain values when the location of the axis is in the first zone, and drive the first coil to control movement of the mover with second set of controller gain values when the location of the axis is in the second zone.

U.S. Pub. No. 2009/0084657 discloses a MODULAR WIRELESS CONVEYOR INTERCONNECTION METHOD AND SYSTEM. The modular conveyor system is disclosed in which components of each conveyor module is designed for wireless mesh communication. The communications may be within a module or between modules. Certain of the components may be powered by battery, such that the components may be completely wireless. The network may be entirely self-configuring such that the modules may be assembled and the network established in a straightforward manner.

The background description provided herein is for the purpose of generally presenting background context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY OF THE INVENTION

This section provides a simplified summary in order to provide a basic understanding of some aspects described herein. This summary is not an extensive overview and is not intended to identify “key” or “critical” elements of the present disclosure or to delineate the scope of the various aspects described herein. The purpose of this portion of the document is to present some concepts in a simplified form as a prelude to the more detailed description that is presented later.

A method of operating a conveying system having a plurality of steerable wheel movers mechanically independent with respect to one another and arranged in a plurality of rows can include directing at least one motor of at least one steerable wheel mover of the plurality of steerable wheel movers, with a mover controller of the at least one steerable wheel mover, to rotate a wheel of the at least one steerable wheel mover about a wheel axis of rotation at a first rotational velocity or to rotate the wheel about a steer angle axis that is normal to the wheel axis of rotation to a first angular orientation about the steer angle axis. The method can also include detecting a change in at least one operating parameter of the at least one steerable wheel mover after the directing other than the change to the directed rotational velocity of the wheel or to the directed angular orientation of the wheel. The method can also include determining, with a master controller of the conveying system, at least a portion of the mass of a package positioned at least in part on the at least one steerable wheel mover based at least in part on the change detected during the detecting.

According to other features, the detecting can be further defined as detecting the change in the at least one operating parameter chosen from the group comprising a current passing through the at least one motor, a power consumption of the at least one motor, a temperature increase of the at least one motor, a rotational velocity of the wheel different than the directed rotational velocity of the wheel, and an angular orientation of the wheel different than the directed angular orientation of the wheel.

In other features, the detecting can be further defined as detecting, with at least one sensor that is external to the at least one steerable wheel mover, the change in the at least one operating parameter of the at least one steerable wheel mover resulting at least in part from the directing other than the rotational velocity of the wheel and the angular orientation of the wheel.

According to additional features, the detecting can be further defined as detecting, with the mover controller of the at least one steerable wheel mover, the change in the at least one operating parameter of the at least one steerable wheel mover resulting at least in part from the directing other than the rotational velocity of the wheel and the angular orientation of the wheel.

According to other features, the directing can be further defined as directing with a first motor of the at least one motor of the at least one steerable wheel mover of the plurality of steerable wheel movers, with the mover controller of the at least one steerable wheel mover, to rotate the wheel of the at least one steerable wheel mover about the wheel axis of rotation at the first rotational velocity and with a second motor of the at least one motor to rotate the wheel about the steer angle axis that is normal to the wheel axis of rotation to the first angular orientation about the steer angle axis. The detecting can be further defined as detecting the change in the at least one operating parameter of only one of the first motor and the second motor of the at least one steerable wheel mover resulting at least in part from the directing other than the rotational velocity of the wheel and the angular orientation of the wheel. The detecting can alternatively be further defined as detecting the change in the at least one operating parameter including a first operating parameter of the first motor and a second operating parameter of the second motor resulting at least in part from the directing other than the rotational velocity of the wheel and the angular orientation of the wheel.

In other features, the detecting can be further defined as detecting a change in at least one operating parameter in the form of a velocity error defined as the difference between the first rotational velocity and an actual rotational velocity of the wheel about the wheel rotation axis after the directing. The determining can be further defined as determining, with the master controller of the conveying system, the at least a portion of the mass of the package positioned at least in part on the at least one steerable wheel based at least in part on the velocity error.

According to additional features, the detecting can be further defined as detecting a change in at least one operating parameter in the form of an angular orientation error defined as the difference between the first angular orientation and an actual angular orientation of the wheel about the steer angle axis after the directing. The determining can be further defined as determining, with the master controller of the conveying system, the at least a portion of the mass of the package positioned at least in part on the at least one steerable wheel based at least in part on the angular orientation error.

According to other features, the directing can be further defined as directing respective at least one motors of a set of steerable wheel movers of the plurality of steerable wheel movers, with respective mover controllers of the set of steerable wheel movers, to rotate respective wheels of the set of steerable wheel movers about respective wheel axes of rotation at the first rotational velocity and to rotate the respective wheels about respective steer angle axes each normal to the respective wheel axes of rotation to the first angular orientation about the respective steer angle axes. The detecting can be further defined as detecting at least one change in at least one operating parameter of each of the set of steerable wheel movers resulting at least in part from the directing.

In other features, the determining can be further defined as determining, with the master controller of the conveying system, the at least a portion of the mass of the package positioned at least in part on the set of steerable wheel movers based at least in part on the changes respectively detected at each of the set of steerable wheels during the detecting. The determining can be further defined as determining, with the master controller of the conveying system, a height of the package positioned at least in part on the set of steerable wheel movers based at least in part on the changes respectively detected at each of the set of steerable wheels during the detecting.

According to additional features, the directing can be further defined as first directing each of the respective at least one motor of a first set of steerable wheel movers of the plurality of steerable wheel movers, with the respective mover controllers of the first set of steerable wheel movers, to rotate the respective wheels of the first set of steerable wheel movers about respective the wheel axes of rotation at the first rotational velocity and to rotate the respective wheels of the first set of steerable wheel movers about respective steer angle axes that are each normal to the respective wheel axis of rotation to the first angular orientation about the respective steer angle axes. The directing can also be further defined as second directing, after the first directing, each of the respective at least one motor of a second set of steerable wheel movers of the plurality of steerable wheel movers, with the respective mover controllers of the second set of steerable wheel movers, to rotate the respective wheels of the second set of steerable wheel movers about the respective wheel axes of rotation of the second set of steerable wheel movers at a second rotational velocity and to rotate the respective wheels of the second set of steerable wheel movers about the respective steer angle axes of the second set of steerable wheel movers, each normal to the respective wheel axis of rotation, to a second angular orientation about the respective steer angle axes of the second set of steerable wheel movers. The detecting can be further defined as first detecting at least one change in at least one operating parameter of each of the first set of steerable wheel movers resulting at least in part from the first directing. The detecting can also be further defined as second detecting, after the first detecting, at least one change in at least one operating parameter of each of the second set of steerable wheel movers resulting at least in part from the second directing. The determining can be further defined as first determining, with the master controller of the conveying system, the at least a portion of the mass of the package positioned on the first set of steerable wheel movers based at least in part on the changes respectively detected at each of the first set of steerable wheels during the first detecting. The determining can also be further defined as second determining, after the first determining, with the master controller of the conveying system, the at least a portion of the mass of the package positioned on the second set of steerable wheel movers based at least in part on the changes respectively detected at each of the second set of steerable wheels during the second detecting and also based at least in part on the first mass load determined during the first determining.

According to other features, the directing can be further defined as first directing each of the respective at least one motor of a first set of steerable wheel movers of the plurality of steerable wheel movers, with the respective mover controllers of the first set of steerable wheel movers, to rotate the respective wheels of the first set of steerable wheel movers about respective the wheel axes of rotation at the first rotational velocity and to rotate the respective wheels of the first set of steerable wheel movers about respective steer angle axes that are each normal to the respective wheel axis of rotation to the first angular orientation about the respective steer angle axes. The directing can also be further defined as second directing, after the first directing, each of the respective at least one motor of a second set of steerable wheel movers of the plurality of steerable wheel movers, with the respective mover controllers of the second set of steerable wheel movers, to rotate the respective wheels of the second set of steerable wheel movers about the respective wheel axes of rotation of the second set of steerable wheel movers at a second rotational velocity and to rotate the respective wheels of the second set of steerable wheel movers about the respective steer angle axes of the second set of steerable wheel movers, each normal to the respective wheel axis of rotation, to a second angular orientation about the respective steer angle axes of the second set of steerable wheel movers. The detecting can be further defined as first detecting at least one change in at least one operating parameter of each of the first set of steerable wheel movers resulting at least in part from the first directing. The detecting can also be further defined as second detecting, after the first detecting, at least one change in at least one operating parameter of each of the second set of steerable wheel movers resulting at least in part from the second directing. The determining can further comprise first determining, with the master controller of the conveying system, a first height of the package positioned on the first set of steerable wheel movers based at least in part on the changes respectively detected at each of the first set of steerable wheels during the first detecting. The determining can also further comprise second determining, after the first determining, with the master controller of the conveying system, a second height of the package positioned on the second set of steerable wheel movers based at least in part on the changes respectively detected at each of the second set of steerable wheels during the second detecting and also based at least in part on the first height determined by the first determining.

In other features, the method can further comprise determining, with the master controller of the conveying system, the first angular orientation about the steer angle axis based at least in part on a second mass load of the package received by the master controller before the directing.

According to additional features, the method can also include comparing, with the master controller, the at least one change in the at least one operating parameter of a first steerable wheel mover of the set of steerable wheel movers of the plurality of steerable wheel movers against the at least one change in the at least one operating parameter of a second steerable wheel mover of the set of steerable wheel movers of the plurality of steerable wheel movers.

According to other features, the detecting can be further defined as detecting a change in at least one operating parameter of the at least one steerable wheel mover after the directing and after the directed rotational velocity of the wheel or the directed angular orientation of the wheel has been reached.

In other features, the detecting can be further defined as detecting a change in at least one operating parameter of the at least one steerable wheel mover after the directing and after the directed rotational velocity of the wheel or to the directed angular orientation of the wheel has been reached and substantially immediately after the wheel has engaged a package has moved into a position at least in part on the at least one steerable wheel mover.

A conveying system can include a plurality of steerable wheel movers, a plurality of sub-controllers, and a master controller. The plurality of steerable wheel movers can be mechanically independent with respect to one another and arranged in a plurality of rows. The plurality of sub-controllers can each be disposed in communication with more than one of the plurality of steerable wheel movers. The master controller can be disposed in communication with all of the plurality of sub-controllers. Each of the plurality of steerable wheel movers can be configured to move packages, wherein each includes a mover controller and at least one motor and a wheel, wherein each of the mover controllers is configured to direct the respective the at least one motor to rotate the respective wheel about a wheel axis of rotation at a first rotational velocity and to rotate the respective wheel about a steer angle axis normal to the wheel axis of rotation to a first angular orientation about the steer angle axis, and each of the respective mover controllers is configured to detect a change in at least one operating parameter of each of the plurality of steerable wheel movers resulting at least in part from the directing of the at least one motor other than the rotational velocity of the wheel and the angular orientation of the wheel. The master controller can be configured to determine at least part of a mass a package positioned at least in part on at least one steerable wheel mover based at least in part on the detected change.

According to other features, for each of the plurality of steerable wheel movers, the respective at least one motor is further defined as a respective first motor configured to rotate the respective wheel about the respective wheel axis of rotation and a respective second motor configured to rotate the respective wheel about the respective steer angle axis.

### BRIEF DESCRIPTION OF THE DRAWINGS

The detailed description set forth below references the following drawings:

FIG. 1 is a top schematic view of a conveying system according to a first exemplary embodiment of the present disclosure;

FIG. 2 is a top schematic view of a conveying system according to a second exemplary embodiment of the present disclosure;

FIG. 3 is a schematic view of a portion of the first exemplary conveying system shown in FIG. 1;

FIG. 4 is a schematic diagram of an exemplary steerable wheel mover; and

FIG. 5 is a schematic view of a portion of the first exemplary conveying system shown in FIG. 1

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide a steerable wheel mover software linkage, in contrast to a mechanical linkage. One or more embodiments of the present disclosure provide a steer-by-wire algorithm and associated motors and controllers that can provide the same functionality of a steerable wheel system interconnection by mechanical linkages. But the exemplary linkages herein are software defined and able to change during operation while not requiring high bandwidth and large networks. Based on firmware loaded into a master controller, two or more wheels can steer together based on a single network message. This permits on-the-fly changes to the linkages among the steerable wheel movers. This provides a main system network communication bandwidth that is only as complex as necessary for the specific use case. When all of the steerable wheel movers in a particular row are controlled to steer together, the main system controller is only sending one message per row of steerable wheel movers. At the same time, embodiments of the present disclosure can achieve the ultimate flexibility provided by re-addressing steerable wheel movers to different sub-groups, including sub-groups, by way of example and not limitation, that include steerable wheel movers in different rows and/or less than all of the steerable wheel movers in a particular row.

Again referring to the simplest form, a sub-group could consist of all movers in one row defined in a perpendicular direction to the conveyor transport direction. In this manner, each row of the steerable wheel modules could have one address and one sub-controller enabling a relatively low cost, low speed network and master system controller. In such an embodiment, each row of movers could steer independently and permit a drastic shrinking of the required space between packages while maintaining a relatively easy control methodology. Furthermore, in contrast to prior systems wherein a dedicated steering motor exists for each row of movers, the present disclosure has an advantage of up time in the event of a failed motor. In most cases, if a single steering motor inside of a mover were to fail, the system operation would not be impacted and a replacement could be scheduled during planned maintenance cycles. Furthermore, the single mover can be understood as a building block such that systems of many different sizes can be built instead of being based on a fixed dimension. This permits rapid customization as well as low-cost upgrades after commissioning. However, when one steering motor is controlling multiple movers such as in prior systems, a failed steering motor can bring down the entire warehouse leading to costly downtime, such a motor cannot be easily upgraded, and it can be more difficult to customize the system.

Embodiments of the present disclosure can ascertain package characteristics, such as dimensional data and mass, based on a collection of steerable wheel mover data that is present within the steerable wheel movers. Furthermore, embodiments of the present disclosure can be configured to continuously refine the determinations of the package characteristics as the package continues to travel down the line. In addition, embodiments of the present disclosure can be configured to take in an estimate of package characteristics to include some or all of the dimensions and mass, and can improve upon the provided estimate by capturing more data and bolstering confidence in the estimate. Moreover, embodiments of the present disclosure can be configured to pass on the estimate to another system identical to itself or a completely different system that is configured to make further improvements on the estimate.

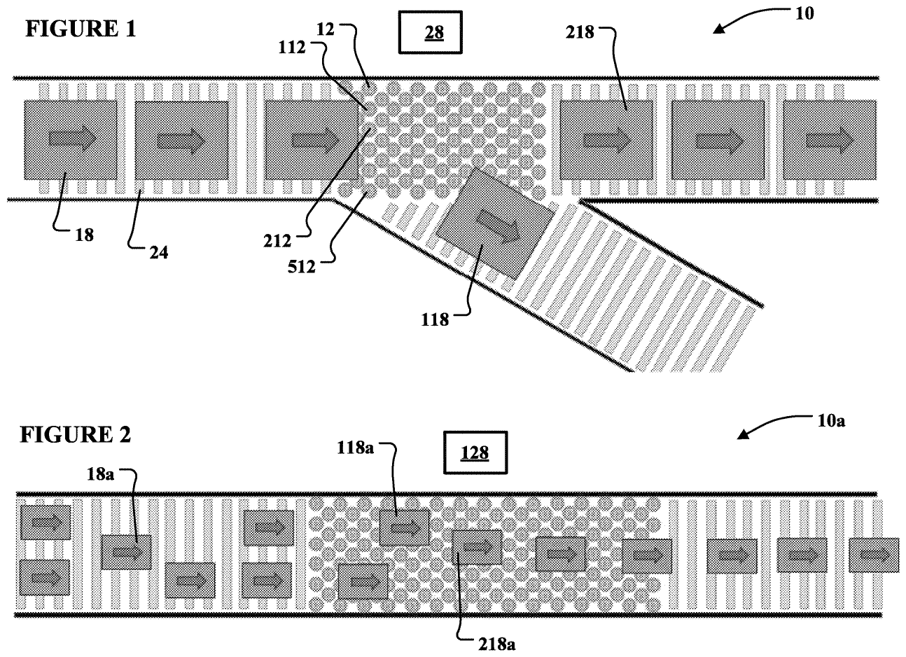

Generally, steerable wheel movers are used in warehouse automation as part of conveyor or conveying systems. The conveying systems can be used to transport boxes, packages, etc., along a transport path. When a package reaches a conveying system section including steerable wheel movers, the movers can steer the package to one of multiple different directions, including going straight or passing off the main conveyor onto another conveyor of some sort headed to either the left or right, at infinitely variable angles. This is considered a divert action and such a section is at least sometimes referred to as a “divert section” or a “diverter.” FIG. 1 is a top schematic view of an exemplary divert section. A second use case for steerable wheel movers is called a “singulator” or “singulator section.” In some operating environments, packages may be coming down a conveyor with two or three or more packages side-by-side. The singulator section rearranges the packages to be in a single-file line. FIG. 2 is a top schematic view of an exemplary singulator section.

The present disclosure provides a conveying system having a plurality of steerable wheel movers mechanically independent with respect to one another and arranged in a plurality of rows and a method of operating the conveying system. FIG. 1 is a top schematic view of a first exemplary embodiment of a conveying system 10 according to the present disclosure; the first exemplary embodiment being in the form a divert section. FIG. 2 is a top schematic view of a second exemplary embodiment of a conveying system 10a according to the present disclosure; the second exemplary embodiment being in the form a singulator section. The method disclosed herein can be executed by both exemplary conveying systems 10, 10a.

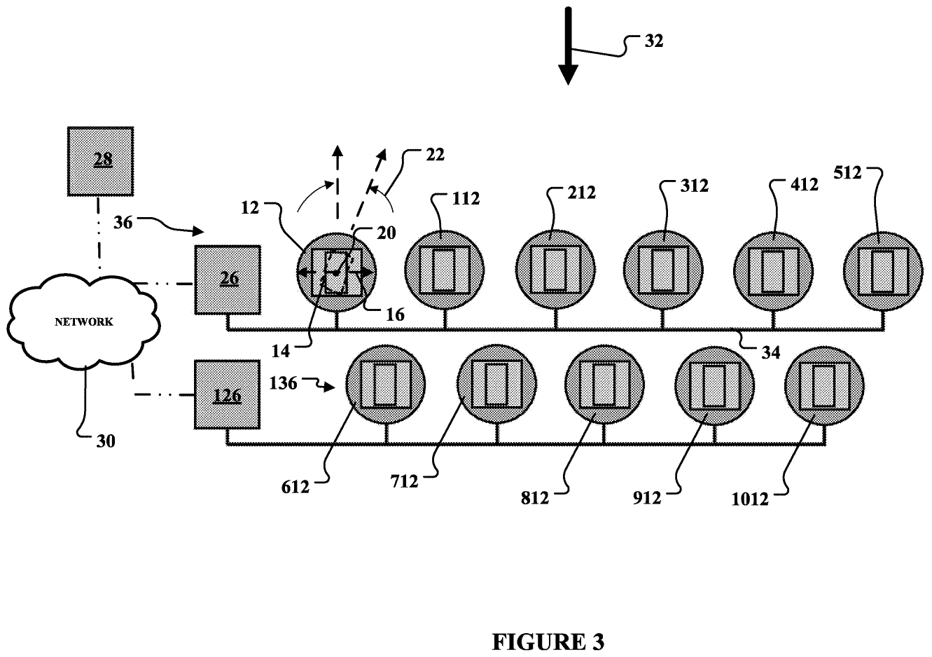

Referring now to FIG. 1, the exemplary conveying system 10 includes a plurality of steerable wheel movers such as exemplary steerable wheel movers 12, 112, 212 . . . 512. The exemplary plurality of steerable wheel movers of the conveying system 10 are arranged in a plurality of rows and the exemplary steerable wheel movers 12, 112, 212 . . . 512 are disposed in the same row, referenced by 36, of the exemplary plurality of rows. It is noted that other, similarly appearing but unnumbered structures shown in FIGS. 1 and 2 are also exemplary steerable wheel movers. FIG. 3 shows the exemplary steerable wheel movers 12, 112, 212 . . . 512 are disposed in the same row with exemplary steerable wheel movers 312 and 412. In one or more embodiments of the present disclosure, a row can be transverse (including but not limited to perpendicular) to a path of movement defined by the conveying system, but this disclosure is not limited to transverse rows. In one or more embodiments of the present disclosure, a row can be linear such as the row defined by the exemplary steerable wheel movers 12, 112, 212, 312, 412, 512, but this disclosure is not limited to linear rows.

Each of the exemplary steerable wheel movers can include a wheel or roller which will contact a package and rotate about a wheel axis of rotation. The exemplary steerable wheel mover 12 will be described in greater detail and is applicable to the other exemplary steerable wheel movers which are configured similarly. Referring now to FIG. 3, the wheel of the exemplary steerable wheel mover 12 is shown as a solid rectangle and is referenced by 14. The wheel axis of rotation of the exemplary wheel 14, when the exemplary wheel 14 is in the position shown in FIG. 3, is referenced by 16. Rotation of the wheel 14 about the axis 16 will move a package contacting the wheel 14. It is noted that packages are referenced in FIG. 1 at 18, 118, and 218 and are referenced in FIG. 2 at 18a, 118a, and 218a. It is noted that other, similarly appearing but unnumbered structures shown in FIGS. 1 and 2 are also exemplary packages.

Each of the exemplary steerable wheel movers can also rotate about a steer angle axis that is perpendicular to the wheel axis of rotation. The exemplary wheel axis of rotation 16 extends across the page of FIG. 3 and the exemplary steer angle axis is coming out of and into the page of FIG. 3 and is referenced at 20. In FIG. 3, the exemplary wheel 14 is shown in solid line while at a first steer angle designated, for exemplary purposes, as a “zero” steer angle. The exemplary wheel 14 is shown in dash line after being rotated about the exemplary steer angle axis 20 to a second steer angle, referenced by 22. The angle 22 corresponds to a first angular position of the wheel 14 about the steer angle axis 20.

It is noted that steerable wheel movers that can be utilized in one or more embodiments of the present disclosure can take various forms. For example, exemplary steerable wheel movers can have a bidirectional roller wheel enabled to spin by a roller motor, such that when acting in contact with a package on a conveying system can propel the package in the direction of the roller. This form of steerable wheel mover can also have a steering mechanism to change the steer angle, enabled by a dedicated steering motor, acting to steer the direction of the roller from 0 to 180 degrees based on the intended direction that the package is controlled. Alternatively, exemplary steerable wheel movers can have a roller that is unidirectional and have the steering mechanism that can act over a range of 0 to 360 degrees.

It is noted that a steerable wheel mover is generally referred to as a diverter unit 11a, 11b in U.S. Pat. No. 7,040,478 and as a pitch independent transmission 50 in U.S. Pat. No. 9,745,143. However, the diverter units 11a and 11b disclosed in U.S. Pat. No. 7,040,478 and pitch independent transmission 50 in U.S. Pat. No. 9,745,143 are mechanically interconnect whereby the diverter units/pitch independent transmissions are moved to a common steer angle at the same time. In contrast, in the present disclosure, the steerable wheel movers are mechanically independent with respect to one another. Mechanically independent refers to each steerable wheel mover being moveable to a different steer angle without such movement being mechanically transferred to or mechanically transferred from another steerable wheel mover.

As shown in FIGS. 1 and 2, an embodiment of a conveying system according to the present disclosure may include sections without steerable wheel movers. Such sections may include non-steerable, wide rollers such as referenced at 24 in FIG. 1 and/or belt sections.

The exemplary conveying system 10 also includes a plurality of sub-controllers 26, 126. Referring now to FIG. 3, an exemplary first sub-controller is referenced at 26 and an exemplary second sub-controller is referenced at 126. Each of the plurality of exemplary sub-controllers is disposed in communication with more than one of said plurality of steerable wheel movers. Referring now to FIG. 3, the exemplary sub-controller 26 is disposed in communication with the exemplary steerable wheel movers 12, 112, 212, 312, 412, 512 and the exemplary sub-controller 126 is disposed in communication with the exemplary steerable wheel movers 612, 712, 812, 912, 1012. The exemplary steerable wheel movers 612, 712, 812, 912, 1012 are arranged in a row 136. Each of the plurality of sub-controllers 26, 126 is thus disposed in communication with all of the plurality of steerable wheel movers that are positioned in the same row of the plurality of rows. In one or more embodiments of the present disclosure, a Texas Instruments F2800137PT can be utilized as a sub-controller.

The exemplary conveying system 10 also includes a master controller that is disposed in communication with all of the plurality of sub-controllers. The master controller is referenced at 28 in FIGS. 1 and 3 and at 128 in FIG. 2. In one or more embodiments of the present disclosure, a Texas Instruments F2800137PT can be utilized as a sub-controller.

Referring again to FIG. 3, the exemplary master controller 28 is disposed in communication with each of the exemplary sub-controllers 26, 126 over a network 30. It is noted that networks are present in the embodiments shown in FIGS. 1 and 2 despite not being shown or referenced. The exemplary network 30, illustrated schematically, can include a local area network (LAN), a wide area network (WAN), e.g., the Internet, a Multi-protocol label switching (MPLS) network, a cellular network such as operated by cellular phone companies, or any combination thereof. The exemplary network 30 can be practiced with a wireless network, a hard-wired network, or any combination thereof. The present disclosure is well suited to a wide variety of computer network systems over numerous topologies.

In the exemplary embodiment of the present disclosure, the master controller 28 is not configured or disposed to communicate commands to the steerable wheel movers 12-1012 but is configured to know the location of each steerable wheel mover in the system 10. Commands can be transmitted to the sub-controllers and the sub-controllers communicate commands to the steerable wheel movers. The exemplary master system controller 28 can “steer” all of the motors that respectively control the steer angle of all of the steerable wheel movers of a sub-group at once by using one message/command on the network 30.

In an exemplary method of operating the exemplary conveying system 10, the master controller 28 can direct a first command to at least the first sub-controller 26. The first command can be directed or transmitted or sent over the network 30. The first command indicates a first sub-group of the plurality of steerable wheel movers. The first sub-group of the plurality of steerable wheel movers is less than all of the plurality of steerable wheel movers. For example, with reference to FIG. 3, a package is moving in a direction referenced by arrow 32 and the exemplary first sub-group of steerable wheel movers can include movers 12, 112 and 212, which is less than all of the plurality of steerable wheel movers. It is noted that FIG. 3 only shows two rows of the steerable wheel movers of the exemplary conveying system 10 shown in FIG. 1. Thus, in this example, the first command indicates/identifies the movers 12, 112 and 212. The first command also indicates a first steer angle. In this example, the first steer angle can be the angle 22. Thus, in this example, the first command indicates/identifies the angle 22. The first command can also indicate a speed of rotation about the wheel axis of rotation. The speed of rotation about the wheel axis of rotation may be the same for all movers of the sub-group. Alternatively, one or more of the movers in a sub-group may be controlled to move at different speeds. Further, movers in a single row may be controlled at different speeds.

Since the exemplary movers 12, 112 and 212 are all under the control of the exemplary sub-controller 26, the master controller 28 can direct the first command to a single address in the network, the address of the exemplary sub-controller 26. Generally, the master controller 28 can direct a command to all of the sub-controllers that communicate with any of the steerable wheel movers that are part of the immediate sub-group of movers. If the immediate sub-group includes movers in multiple rows, the master controller 28 can direct a command to multiple sub-controllers. It is noted that in some operating circumstances, a single sub-controller may be communicating with movers in multiple sub-groups and thus receive multiple commands substantially concurrently.

After the first command is sent by the master controller 28, in this example, it can be received by the exemplary first sub-controller 26. It is noted that the present disclosure contemplates the first sub-controller 26 receiving the first command directly or indirectly from the master controller 28. After receiving the first command and in response thereto, the exemplary first sub-controller 26 can control the exemplary movers 12, 112 and 212 to move to the steer angle 22. The exemplary first sub-controller 26 can send a control signal over a bus 34 that is distinct from the network 30 and each of the exemplary movers 12, 112 and 212 is connected to the bus 34. After receiving the control/command from the exemplary sub-controller 26 and in response thereto, the exemplary movers 12, 112, 212 move to the directed steer angle and rotate at the directed wheel speed and moving the package travelling along the exemplary conveying system 10.

After directing the first command, the master controller 28 can dynamically determine subsequent, successive sub-groups of steerable wheel movers to further effect the movement of packages along the exemplary conveying system 10. Like the first sub-group, the exemplary master controller 28 can determine second, third, fourth, etc., sub-groups of steerable wheel movers that are each different than immediately preceding sub-groups and each of these sub-groups can be defined by less than all of the steerable wheel movers of exemplary conveying system 10.

The exemplary conveying system 10 can include a plurality of sensors that, during operation, generate signals about the speed of movement and the size of packages positioned on the steerable wheel movers or upstream of the steerable wheel movers. In addition, the steerable wheel movers can transmit operating data such as motor current, position error (difference between commanded position and actual position), velocity error (difference between commanded velocity and actual velocity), motor power consumption, and motor temperature rise that indicates the locations of packages. In addition, data about the identity of each package, such as its delivery location, can be transmitted to the exemplary conveying system 10.

This data can be received and processed by the exemplary master controller 28 to determine the location of each package supported by the exemplary conveying system 10, in order to determine the identities of the steerable wheel movers to include in a sub-group that will next move that package. In one or more other embodiments of the present disclosure, the data can be received and processed by another computing device which determines the location of each package supported by the exemplary conveying system 10 to reduce the processing burden on the master controller 28. These locations can be communicated to the exemplary master controller 28, whereby the exemplary master controller 28 can then determine the identities of the steerable wheel movers to include in a sub-group that will next move that package.

The exemplary master controller 28 is configured to determine the identities of the steerable wheel movers in the second sub-group based on the sizes and locations of packages moving along the exemplary conveying system 10. Because the steerable wheel movers are mechanically independent, the exemplary master controller 28 can select any combination of steerable wheel movers to most effectively continue movements of the packages along the exemplary conveying system 10. A sub-group can be defined by steerable wheel movers in different rows of the plurality of rows. A sub-group can include only steerable wheel movers in the same row of the plurality of rows. A sub-group can include, in a second sub-group, one or more of the steerable wheel movers that had been included in a prior, first sub-group of steerable wheel movers.

In one example, the exemplary master controller 28 can determine a second sub-group that is successive or subsequent to the first sub-group and includes steerable wheel movers in different rows. For example, referring to FIG. 3, the exemplary master controller 28 can determine the first sub-group to include the exemplary steerable wheel movers 12 and 112 and direct the first command to the exemplary sub-controller 26. Next, as a package is being moved by the exemplary steerable wheel movers 12 and 112, the exemplary master controller 28 can determine the second sub-group to include the exemplary steerable wheel movers 12, 112, 612, and 712. Thus, in this example, the second sub-group of the plurality of steerable wheel movers is different than the first sub-group of the plurality of steerable wheel movers, is less than all of the steerable wheel movers of the exemplary conveying system 10, and includes at least one first steerable wheel mover positioned in a first row 36 of the plurality rows and a second steerable wheel mover positioned in a second row 136 of the plurality rows that is different than the first row 36 of the plurality rows. The exemplary master controller 28 could then direct the second command to both sub-controllers 26, 126. The second command would then be received by the exemplary first sub-controller 26 and the exemplary second sub-controller 126. The exemplary first sub-controller 26 would then control the steerable wheel movers 12, 112 to move to the second steer angle and the exemplary second sub-controller 126 would then control the steerable wheel movers 612, 712 to move to the second steer angle. This example also demonstrates the determination of a subsequent, second sub-group that includes at least one steerable wheel mover that was part of a prior, first sub-group of steerable wheel movers.

So, in the example above, a first package can be moved first by the exemplary steerable wheel movers 12, 112, with the exemplary steerable wheel movers 12, 112. After sending the first command to effectuate this movement, the exemplary master controller 28 can determine the exemplary steerable wheel movers 12, 112, 612, 712 as the sub-group steerable wheel movers that will next move this first package and send the second command so that exemplary steerable wheel movers 12, 112, 612, 712 are all at the desired steer angle. It is noted that in response to some operating conditions the first steer angle and the second steer angle may be the same.

In another example, the exemplary master controller 28 can determine a second sub-group that is successive or subsequent to the first sub-group and includes steerable wheel movers in the same row. For example, referring to FIG. 3, the exemplary master controller 28 can determine the first sub-group to include the exemplary steerable wheel movers 12 and 112 and direct the first command to the exemplary sub-controller 26. Next, as another package is being moved toward the row 36, the exemplary master controller 28 can determine the second sub-group to include the exemplary steerable wheel movers 312, 412, and 512. Thus, in this example, the second sub-group of the plurality of steerable wheel movers is different than the first sub-group of the plurality of steerable wheel movers, is less than all of the steerable wheel movers of the exemplary conveying system 10, and includes steerable wheel movers positioned in the same row as the first sub-group. The exemplary master controller 28 could then direct the second command to the exemplary sub-controller 26. The exemplary first sub-controller 26 would then control the steerable wheel movers 312, 412, 512 to move to the second steer angle. This example also demonstrates the determination of a second sub-group that includes none of the steerable wheel movers that were part of a prior, first sub-group of steerable wheel movers. It is noted that in response to some operating conditions, such as when two packages are moving side-by-side to the row 36, the first and second commands can both be sent to the exemplary sub-controller 26 at the same time (or substantially at the same time, as processing and hardware capabilities permit).

In another example, the exemplary master controller 28 can determine a second sub-group that is successive or subsequent to the first sub-group, includes steerable wheel movers in the same row, and also includes steerable wheel movers that had been in the first sub-group. For example, referring to FIG. 3, the exemplary master controller 28 can determine the first sub-group to include the exemplary steerable wheel movers 12 and 112 and direct the first command to the exemplary sub-controller 26. Next, as another package is being moved toward the row 36, the exemplary master controller 28 can determine the second sub-group to include the exemplary steerable wheel movers 112, 212, and 312. Thus, in this example, the second sub-group of the plurality of steerable wheel movers is different than the first sub-group of the plurality of steerable wheel movers, is less than all of the steerable wheel movers of the exemplary conveying system 10, includes steerable wheel movers positioned in the same row as the first sub-group, and involves the “switch” of the exemplary steerable wheel movers 112 from the first sub-group to the second sub-group. The exemplary master controller 28 could then direct the second command to the exemplary sub-controller 26. The exemplary first sub-controller 26 would then control the steerable wheel movers 112, 212, 312 to move to the second steer angle.

In another example, the exemplary master controller 28 can determine a second sub-group and further sub-groups that are fully or partially contemporaneous with the first sub-group. For example, referring to FIG. 3, the exemplary master controller 28 can determine a first sub-group to include the exemplary steerable wheel movers 12 and 112, a second sub-group to include the exemplary steerable wheel movers 212 and 312, and a third sub-group to include the exemplary steerable wheel movers 412 and 512. Multiple sub-groups defined on a single row can be desirable to address multiple packages on or approaching a single row at the same time. The exemplary master controller 28 can direct a first command for the first sub-group, a second command for the second sub-group, and a third command for the third sub-group to the exemplary sub-controller 26. Each of the first command, the second command, and the third command may indicate a different steer angle. The exemplary master controller 28 can send the commands to the exemplary sub-controller 26 at the same time (or substantially at the same time, as processing and hardware capabilities permit). Thus, each of the first, second and third sub-groups can be separately addressable and responded to by the exemplary sub-controller 26. Each sub-controller can thus respond to one or more than one address on the network 30.

In another example, the exemplary master controller 28 can determine that all of the movers in a particular row define in whole or in part a particular sub-group.

It is noted that the examples disclosed above can also occur in the embodiment of the disclosure shown in FIG. 2.

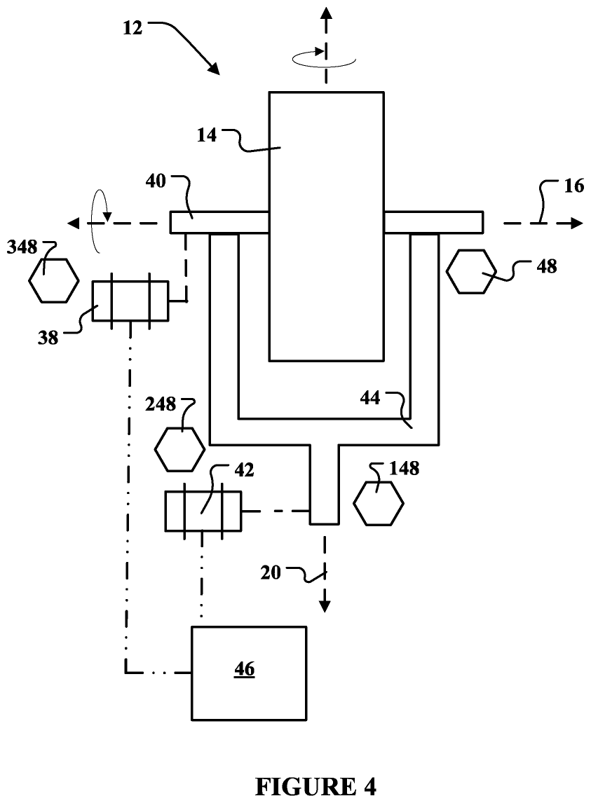

Referring now to FIG. 4, the exemplary steerable wheel mover 12 is representative of all of the exemplary steerable wheel movers and includes the wheel 14 that is rotatable around the wheel axis 16 of rotation and is also rotatable around the steer angle axis 20. Each of the exemplary steerable wheel movers can include at least one motor. The exemplary steerable wheel mover 12 includes an exemplary first motor 38. The exemplary first motor 38 is configured to rotate the wheel 14 about the wheel axis 16 of rotation. FIG. 4 schematically shows the exemplary first motor 38 engaged with an exemplary axle 40 on which the exemplary wheel 14 is mounted. The exemplary first motor 38 can be configured to rotate the wheel 14 is both directions about the wheel axis 16 of rotation. The exemplary steerable wheel mover 12 also includes an exemplary second motor 42. The exemplary second motor 42 is configured to rotate the wheel 14 about the steer angle axis 20 to any desired angle/angular position about the steer angle axis 20. FIG. 4 schematically shows the exemplary second motor 42 engaged with an exemplary yoke 44 on which the exemplary axle 40 of the wheel 14 is supported for rotation.

The exemplary steerable wheel mover 12 also includes an exemplary mover controller 46. The exemplary mover controller 46 is configured to receive commands from the respective sub-controller, in this example sub-controller 26 shown in FIG. 3. In one or more embodiments of the present disclosure, a Texas Instruments F2800137PT can be utilized as a sub-controller. In the exemplary embodiment, such commands can originate at the exemplary master controller 28, also shown in FIG. 3. In response to received commands, the exemplary mover controller 46 is configured to direct the exemplary first motor 38 and/or the exemplary second motor 42 to rotate the wheel 14 about the wheel axis 16 of rotation at a first rotational velocity and/or to rotate the wheel 14 about the steer angle axis 20 a first angular orientation about the steer angle axis 20. It is noted that in FIG. 3 a first form of dash lines is used to represent mechanical interconnection and a second form of dash lines is used to represent electrical interconnection (power and/or data communication). FIG. 3 shows an exemplary angular position referenced by the angle 22. The first rotational velocity and/or the first angular orientation can be included in the command received by the exemplary mover controller 46. In response to the direction from the exemplary mover controller 46, the exemplary motors 38, 42 respond as directed.

After the direction from the exemplary mover controller 46 has been executed by the exemplary first motor 38 and/or the exemplary second motor 42, a change in at least one operating parameter, other than the rotational velocity of the wheel 14 and/or the angular orientation of the wheel 14, of the exemplary first motor 38 and/or the exemplary second motor 42 can be detected. The detection can be executed after the directed rotational velocity of the wheel and/or the directed angular orientation of the wheel has been reached, so the detection is made to detect the consequence of engagement of the mover with a package; the change being detected substantially immediately after the wheel has engaged a package has moved into a position at least in part on the at least one steerable wheel mover. Each of the two exemplary motors 38, 42 yield a plurality of operating parameters that can change with respect to time during operation and a change in at least one of these operating parameters can be detected by the exemplary mover controller 46. Alternatively or additionally, a change in at least one operating parameter can be detected by one or more sensors that are external to the exemplary steerable wheel mover 12. An exemplary external sensor 48 shown in FIG. 3 can be configured to sense the actual rotational velocity of the wheel 14. An exemplary external sensor 148 shown in FIG. 3 can be configured to sense the actual angular position of the wheel 14. Exemplary external sensors 248, 348 are shown in FIG. 3 and can be configured to respectively sense a condition of the exemplary second motor 42 or exemplary first motor 38, such as temperature. Data corresponding to a change in an operating parameter could also be captured by sensors that are installed in the exemplary steerable wheel mover 12, such as a separate encoder or Hall effect sensor to detect motor speed.

Various parameters can be monitored in one or more embodiments of the present disclosure. For example, the monitored operating parameter can be the current of one or both of the exemplary motors 38, 42; a temperature change of one or both of the exemplary motors 38, 42; and/or the power consumption of one or both of the exemplary motors 38, 42. It is also noted that, in one or more embodiments of the present disclosure, more than one operating parameter can be monitored. In one or more embodiments of the present disclosure, a monitored parameter can be a velocity error, which is defined as the difference between the commanded or directed rotational velocity and the actual rotational velocity. In one or more embodiments of the present disclosure, a monitored parameter can be a position error, which is defined as the difference between commanded or directed angular position and actual angular position. Other parameters associated with the operation of one or both of the exemplary motors 38, 42 can also be detected and monitored and could be considered in other embodiments of the present disclosure. Data associated with at least some of the parameters mentioned above can be produced directly from the exemplary mover controller 46 as a part of the fundamental data that is available as a part of standard motor control. Other parameters can be specifically measured by the exemplary mover controller 46 even if they are not a part of standard motor control data.

The change in the at least one parameter, occurring as a result of the exemplary steerable wheel mover 12 directing one or both of the exemplary motors 38, 42 to rotate the exemplary wheel 14, can be detected relatively immediately after the direction is received and starts being executed. For example, a change in the current being directed through one or both of the exemplary motors 38, 42 would be such a parameter change. Alternatively, the change in the parameter can be detected when the direction has been executed. For example, the power consumption or temperature increase of one or both of the exemplary motors 38, 42 are such parameter changes. Alternatively, the change in the parameter can be detected as the direction is being executed. Velocity error and position error are examples of such a parameter change.

The change in the at least one parameter, occurring as a result of the exemplary steerable wheel mover 12 directing one or both of the exemplary motors 38, 42 to rotate the exemplary wheel 14, can be communicated to the exemplary master controller 28. In various embodiments, the parameter change can be communicated by the exemplary mover controller 46, one or more external sensors if utilized, and/or one of the sub-controllers. In various embodiments, the parameter change can be communicated over the exemplary network 30 or can be communicated over a second network so that the exemplary network 30 can be dedicated for communications between the exemplary master controller 28 and the plurality of sub-controllers.

After receiving the data of the at least one parameter change, the exemplary master controller 28 can determine at least a portion of the mass of the package 18 that is positioned at least in part on the exemplary steerable wheel mover 12 based at least in part on the change in the at least one parameter. In the exemplary embodiment, the exemplary master controller 28 can determine the mass of the package 18 that is positioned at least partially on the exemplary steerable wheel mover 12 based on the detected parameter change. The determination can be based on data stored in memory and accessible by the exemplary master controller 28. For example, the exemplary master controller 28 can have access to a table stored in a memory that correlates changes in the at least one parameter to masses of packages. Such a table can be updated and improved over time. In another example, the exemplary master controller 28 can be calibrated before operation and then during operation determine package mass based on the change in the at least one parameter.

The exemplary master controller 28 can be configured to weigh changes in multiple parameters in determining the mass of the package. While one detected parameter change may indicate a first mass, a second detected parameter may indicate a second mass different than the first mass. In such a circumstance, by way of example and not limitation, the exemplary master controller 28 can be configured to determine the package mass to be the average of the first mass and the second mass. In another non-limiting example, the exemplary master controller 28 can be configured to determine the package mass between the first mass and the second mass, but closer to the first mass than the second mass if the first mass is associated with an operating parameter that has been found to correlate more closely to package mass.

In another non-limiting example, position error can be the parameter detected to determine the package mass. The position error would be higher during the steering motion (when the wheel 14 is being rotated about the steer angle axis 20) when a package is present on the exemplary steerable wheel mover 12. Meanwhile, the motor current can be also monitored and the combination of these two parameters can constitute a data set applied to determine package mass. However, when a divert action is not happening (no steering motion), the position error may be unaffected by the package. So, in this example, only the motor current magnitude could be used by the master controller 28 to determine the package mass. However, it is noted that even when the divert action is not taking place the mass can impact the steering angle error. Because a package can hit a mover unevenly, it can cause a force on one side of the wheel differently than the other. Because these motors are constantly monitoring position, they can hold their position but they are still impacted and current can flow in the case of uneven forces applied to the steering mechanism.

As set forth above, a command sent by the master controller 28 can prompt the concurrent action of a sub-group or set of the plurality of steerable wheel movers. The command will effectuate the movement of a package along the system 10. Each mover controller of each of the steerable wheel movers of a particular sub-group or set can control its motor(s) to move its wheel as necessary to rotate at the first rotational velocity and rotate to the first angular position. The respective operation of each steerable wheel mover of the set can be monitored and change in at least one parameter can be detected for each steerable wheel mover of the set and communicated to the exemplary master controller 28. Thus, the exemplary master controller 28 can determine the mass of a package positioned currently on the set of steerable wheel movers, based on all of the changes respectively detected at each steerable wheel mover of the set or sub-group of steerable wheel movers.

Each of the respective parameter changes, for each steerable wheel mover of the set, may indicate to the exemplary master controller 28 a number of different, possible masses of the package that is then currently positioned on the set. The exemplary master controller 28 can be configured to determine the mass of the package to be the highest mass corresponding to any one of the parameter changes. Alternatively, the exemplary master controller 28 can be configured to determine the mass of the package to be the average of all masses that correspond to the parameter changes in the set. Alternatively, the exemplary master controller 28 can be configured to determine the mass of the package to be a value that is derived by a statistical model applied to all of the respective parameter changes received by the exemplary master controller 28. It is also noted that the most likely package mass comes from the sum of all reported masses from each mover. Alternatively, the package mass can be determined using the average reported mass from each mover and multiplying by the number of movers. It should not be assumed that the master controller is receiving the entire package mass estimate from each mover but, instead, each mover can be transmitting one or more estimates, perhaps from more than one parameter change, of the mass it is respectively experiencing. The master controller can then add up all the mass estimates/determinations received from all of the movers.

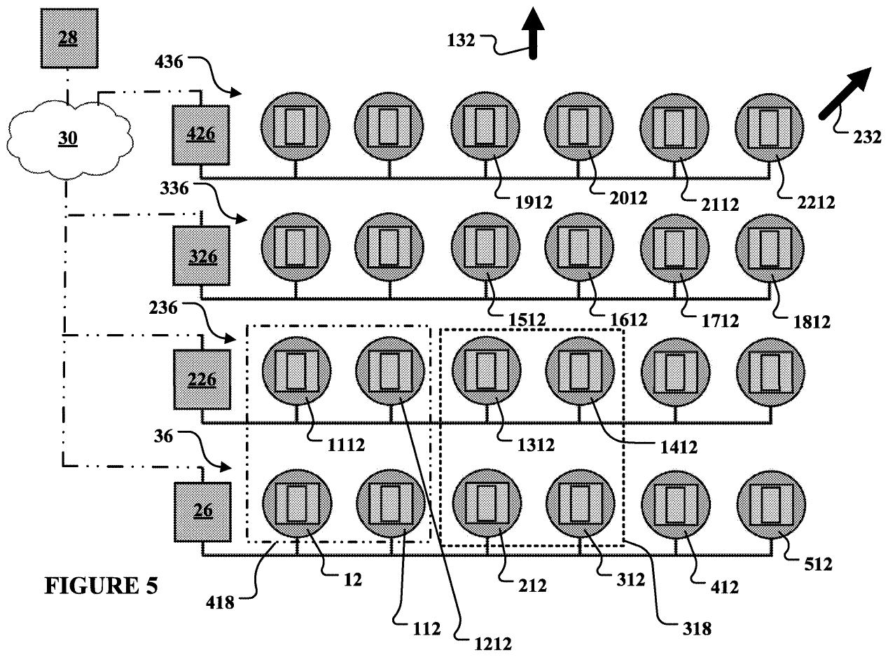

FIG. 5 will now be referenced to detail alternative, exemplary sequences of operations in the exemplary embodiment of the present disclosure. FIG. 5 is a schematic view of a portion, four rows 36, 236, 336, 436, of the first exemplary conveying system 10 shown in FIG. 1. In a first exemplary sequence, the portion of the system 10 can receive a package having a footprint represented by box 318. A footprint of a package can be an area defined by a length and a width of the package. In the first exemplary sequence, the package 318 will be moved in the direction represented by arrow 132. A leading edge of the exemplary package 318 is the linear edge shown in FIG. 5 that is closest to the row 336 and a trailing edge of the exemplary package 318 is linear edge shown in FIG. 5 that is furthest from the row 336.

When the leading edge of the exemplary package 318 enters the row 36 and is engaged by the exemplary movers 212 and 312, current through the first motors of the exemplary movers 212 and 312 will spike. The “first” motors of the exemplary movers 212 and 312 are the motors that drive the respective wheels of the exemplary movers 212 and 312 to rotate about their respective wheel axes of rotation. The exemplary motor controller 28 can receive data of these current spikes to recognize the engagement by exemplary movers 212 and 312 on the underside of the exemplary package 318, to thus detect entry of the exemplary package 318 to the row 36. It is also noted that the system 10 can be configured such that the exemplary motor controller 28 can have received data on the position and speed of movement of the exemplary package 318 before the entry of the exemplary package 318 to the row 36 indicated by the current spikes. Further, the system 10 can be configured such that the exemplary motor controller 28 can have received data on the size of the footprint of the exemplary package 318 before the entry of the exemplary package 318 to the row 36 indicated by the current spikes.

In one or more embodiments of the present disclosure, substantially immediately prior to the exemplary package 318 reaching the position shown in FIG. 5, the exemplary master controller 28 can determine that the exemplary package 318 will reach the position shown in FIG. 5 and, further, can determine that the exemplary steerable wheel movers 212, 312, 1312, 1412, will define a “next” sub-group or set of steerable wheel movers to continue the movement the exemplary package 318. When the exemplary package 318 reaches the position shown in FIG. 5, the exemplary master controller 28 can communicate a command to the sub-controllers 26 and 226 indicating the first rotational velocity and the first angular position that the mover controllers of the exemplary steerable wheel movers 212, 312, 1312, 1412 are to implement. In the first exemplary sequence, the first angular position would be zero or, based on the orientation of the wheels shown in FIG. 5, no movement of the respective wheels about their respective steer angle axes.

When the exemplary steerable wheel movers 212, 312, 1312, 1412 have implemented the command originated from the exemplary master controller 28, one or more changes, in one or more operating parameters, for each of the exemplary steerable wheel movers 212, 312, 1312, 1412 are detected and communicated to the exemplary master controller 28. Based on the detected parameter changes, the exemplary master controller 28 can determine a mass of the exemplary package 318. It is also noted that the system 10 can be configured such that the exemplary motor controller 28 can have received data on the mass of the exemplary package 318 before the entry of the exemplary package 318 to the row 36. Thus, the determination of the mass based on the parameter changes associated with the exemplary steerable wheel movers 212, 312, 1312, 1412 can be a secondary, or further, determination of mass of the exemplary package 318. This allows the system 10 to continuously refine the mass determination as a package moves through the system; specifically, the exemplary master controller 28 can determine the mass of the exemplary package 318 based on the parameter changes associated with the exemplary steerable wheel movers 212, 312, 1312, 1412 as well as based on a prior mass determination. For example, the exemplary master controller 28 can determine the mass of the exemplary package 318 to be the average of all prior mass determinations and the present mass determination that is based on the parameter changes associated with the exemplary steerable wheel movers 212, 312, 1312, 1412. It is noted that approaches other than averaging can be applied in one or more embodiments of the present disclosure.

In further action of the first exemplary sequence, substantially immediately prior to the exemplary package 318 moving from the position shown in FIG. 5, the exemplary master controller 28 can determine that the exemplary package 318 will next reach a position above the exemplary steerable wheel movers 1312, 1412, 1512, 1612 and these movers will define the next sub-group or set of steerable wheel movers to continue the movement the exemplary package 318. When the exemplary package 318 reaches the position above the exemplary steerable wheel movers 1312, 1412, 1512, 1612, the exemplary master controller 28 can communicate a command to the sub-controllers 226 and 326 indicating a second rotational velocity and a second angular position that the mover controllers of the exemplary steerable wheel movers 1312, 1412, 1512, 1612 are to implement. In the first exemplary sequence, the second angular position would be zero and the second rotational velocity could be the same or different relative to the first rotational velocity.

When the exemplary steerable wheel movers 1312, 1412, 1512, 1612 have implemented the command originated from the exemplary master controller 28, one or more changes, in one or more operating parameters, for each of the exemplary steerable wheel movers 1312, 1412, 1512, 1612 are detected and communicated to the exemplary master controller 28. Based on the detected parameter changes in the exemplary steerable wheel movers 1312, 1412, 1512, 1612 as well as the mass determined based on the parameters changes of the sub-group including the exemplary steerable wheel movers 212, 312, 1312, 1412 as well as any other prior determined masses, the exemplary master controller 28 can determine a mass of the exemplary package 318.

In further action of the first exemplary sequence, substantially immediately prior to the exemplary package 318 moving from the position above the exemplary steerable wheel movers 1312, 1412, 1512, 1612, the exemplary master controller 28 can determine that the exemplary package 318 will next reach a position above the exemplary steerable wheel movers 1512, 1612, 1912, 2012 and these movers will define the next sub-group or set of steerable wheel movers to continue the movement the exemplary package 318. When the exemplary package 318 reaches the position above the exemplary steerable wheel movers 1512, 1612, 1912, 2012, the exemplary master controller 28 can communicate a command to the sub-controllers 326 and 426 indicating a third rotational velocity and a third angular position that the mover controllers of the exemplary steerable wheel movers 1512, 1612, 1912, 2012 are to implement. In the first exemplary sequence, the third angular position would be zero and the third rotational velocity could be the same or different relative to either of the first rotational velocity and the second rotational velocity.

In a second exemplary sequence, the portion of the system 10 can receive a package having a footprint represented by box 418. In the second exemplary sequence, the package 418 will be moved in the direction represent by arrow 232. A leading edge of the exemplary package 418 is the linear edge shown in FIG. 5 that is closest to the row 336 and a trailing edge of the exemplary package 418 is linear edge shown in FIG. 5 that is furthest from the row 336.

When the leading edge of the exemplary package 418 enters the row 36 and is engaged by the exemplary movers 12 and 112, current through the first motors of the exemplary movers 12 and 112 will spike. The “first” motors of the exemplary movers 12 and 112 are the motors that drive the respective wheels of the exemplary movers 12 and 112 to rotate about their respective wheel axes of rotation. The exemplary motor controller 28 can receive data of these current spikes to recognize the engagement by exemplary movers 12 and 112 on the underside of the exemplary package 418, to thus detect entry of the exemplary package 418 to the row 36. It is also noted that the system 10 can be configured such that the exemplary motor controller 28 can have received data on the position and speed of movement of the exemplary package 418 before the entry of the exemplary package 418 to the row 36 indicated by the current spikes. Further, the system 10 can be configured such that the exemplary motor controller 28 can have received data on the size of the footprint of the exemplary package 418 before the entry of the exemplary package 418 to the row 36 indicated by the current spikes.

In one or more embodiments of the present disclosure, substantially immediately prior to the exemplary package 418 reaching the position shown in FIG. 5, the exemplary master controller 28 can determine that the exemplary package 418 will reach the position shown in FIG. 5 and, further, can determine that the exemplary steerable wheel movers 12, 112, 1112, 1212, will define a “next” sub-group or set of steerable wheel movers to continue the movement the exemplary package 418. When the exemplary package 418 reaches the position shown in FIG. 5, the exemplary master controller 28 can communicate a command to the sub-controllers 26 and 226 indicating the first rotational velocity and the first angular position that the mover controllers of the exemplary steerable wheel movers 12, 112, 1112, 1212 are to implement. In the second exemplary sequence, the first angular position would correspond to substantially forty-five degrees.

When the exemplary steerable wheel movers 12, 112, 1112, 1212 have implemented the command originated from the exemplary master controller 28, one or more changes, in one or more operating parameters, for each of the exemplary steerable wheel movers 12, 112, 1112, 1212 are detected and communicated to the exemplary master controller 28. Based on the detected parameter changes, the exemplary master controller 28 can determine a mass of the exemplary package 418. It is noted that the determination of the mass based on the parameter changes associated with the exemplary steerable wheel movers 12, 112, 1112, 1212 can be a secondary, or further, determination of mass of the exemplary package 418 and that the exemplary master controller 28 can determine the mass of the exemplary package 418 based on the parameter changes associated with the exemplary steerable wheel movers 12, 112, 1112, 1212 as well as based on a prior mass determination.

In further action of the second exemplary sequence, substantially immediately prior to the exemplary package 418 moving from the position shown in FIG. 5, the exemplary master controller 28 can determine that the exemplary package 418 will next reach a position above the exemplary steerable wheel movers 1312, 1412, 1512, 1612 and these movers will define the next sub-group or set of steerable wheel movers to continue the movement the exemplary package 418. When the exemplary package 418 reaches the position above the exemplary steerable wheel movers 1312, 1412, 1512, 1612, the exemplary master controller 28 can communicate a command to the sub-controllers 226 and 326 indicating a second rotational velocity and a second angular position that the mover controllers of the exemplary steerable wheel movers 1312, 1412, 1512, 1612 are to implement. In the second exemplary sequence, the second angular position would be substantially forty-five degrees.

When the exemplary steerable wheel movers 1312, 1412, 1512, 1612 have implemented the command originated from the exemplary master controller 28, one or more changes, in one or more operating parameters, for each of the exemplary steerable wheel movers 1312, 1412, 1512, 1612 are detected and communicated to the exemplary master controller 28. Based on the detected parameter changes in the exemplary steerable wheel movers 1312, 1412, 1512, 1612 as well as the mass determined based on the parameters changes of the sub-group including the exemplary steerable wheel movers 12, 112, 1112, 1212 as well as any other prior determined masses, the exemplary master controller 28 can determine a mass of the exemplary package 418.

In further action of the second exemplary sequence, substantially immediately prior to the exemplary package 418 moving from the position above the exemplary steerable wheel movers 1312, 1412, 1512, 1612, the exemplary master controller 28 can determine that the exemplary package 418 will next reach a position above the exemplary steerable wheel movers 1712, 1812, 2112, 2212 and these movers will define the next sub-group or set of steerable wheel movers to continue the movement the exemplary package 418. When the exemplary package 418 reaches the position above the exemplary steerable wheel movers 1712, 1812, 2112, 2212, the exemplary master controller 28 can communicate a command to the sub-controllers 326 and 426 indicating a third rotational velocity and a third angular position that the mover controllers of the exemplary steerable wheel movers 1712, 1812, 2112, 2212 are to implement. In the second exemplary sequence, the third angular position would be zero and the third rotational velocity could be the same or different relative to either of the first rotational velocity and the second rotational velocity.

The exemplary master controller 28 can also be configured to determine a height of the package positioned at least in part on the set of exemplary steerable wheel movers based at least in part on the changes respectively detected at each of the set of steerable wheel movers during said detecting. As set forth above, the parameter changes can be applied by the exemplary master controller 28 to determine a mass of the package. Also, as set forth above, the exemplary master controller 28 is configured to select the steerable wheel movers that will be in a sub-group or set to move the package. The exemplary master controller 28 is thus configured to know the footprint of the package in order to select the identities of the steerable wheel movers in the set that will move the package as the steerable wheel movers chosen for the set can correspond to foot print of the package. The exemplary master controller 28 can be also be configured to store in memory a value for an average package density, which can be updated as necessary. With the mass, the footprint of the package, and the average package density, the height of the package can be determined by the exemplary master controller 28.

It is noted that the conveying system 10 can include one or more photo eyes and/or one or more two-dimensional or three-dimensional camera systems configured to determine one or more dimensions of a package at it travels through the conveying system. Such data can be accessible by the master controller 28 and used to improve the accuracy of footprint and height determinations. Similarly, the conveying system 10 can include one or more mass detection plate (scales) configured to determine one or more dimensions of a package such as mass as it travels through the conveying system. Such data can be accessible by the master controller 28 and used to improve the accuracy of mass determinations.

The exemplary master controller 28 can also be configured to repeatedly determine the footprints of packages and iteratively improve the accuracy of determined footprints. The process disclosed above for determining mass can be applied similarly to the determination of footprints. Improved determination of footprints can improve the identification of steerable wheel movers to be included in sub-groups/sets and also improve the accuracy of height determinations.

In another non-limiting example, a conveying system according to one or more embodiments of the present disclosure can be 12 steerable wheel movers wide and 24 steerable wheel movers long with a wheel pitch of three inches, producing a table that is thirty-six inches wide by seventy-two inches long. If a package having a footprint of twelve inches by twelve inches is conveyed through this system, it can engage 16 steerable wheel movers assuming it is positioned square with the side of the table. Each of these 16 steerable wheel movers is producing a portion of the work required to propel the package forward. The fact that these steerable wheel movers are producing work in comparison to the steerable wheel movers not producing work causes at least one change in one or more of a parameter set that is selected for monitoring from all possible parameters available for monitoring. This at least one change can be detected by the exemplary master controller 28 and can be used to determine the package size in two dimensions. Furthermore, the magnitude of the change in the at least one parameter can be summed together with all actively work-producing steerable wheel movers to arrive at a numerical value that the exemplary master controller 28 can correlate with the mass of the package. Furthermore, based on an average package density per square area, a vertical dimension can be determined.

Another benefit arising from the exemplary embodiments of the present disclosure, as well as other possible embodiments, is that the exemplary conveying system 10 defines a closed-loop divert and the exemplary conveying system 10a defines a closed-loop singulator. In the case of a divert action, packages of different sizes and weights are moving through the system 10 over time. Where a package is to be diverted (the angular orientation/steer angle to be non-zero), a relatively heavy package may require a different angular orientation to accurately be diverted than a lighter package requires. Current systems in the art are configured to have a single steer angle that defines a compromise based on average package characteristics. The disclosed system 10 can learn the package characteristics based on the steerable wheel mover parameters and can change the steer angle to change the trajectory of divert in order to accurately position all packages, independent of weight and size, to a subsequent conveyor in a centered and orderly position. The case of the singulator is nearly identical as the system can act to perform singulation based on the learning of package characteristics it can accomplish on its own. Further, the exemplary systems 10, 10a can also take in package characteristics and pair the input data with its own captured data to have an improved system performance. Thus, the exemplary master controller 28 can determine the first angular orientation about the steer angle axis 20 based at least in part on a second mass load of the package that was received by the master controller before the directing by the steerable wheel movers.

Still another benefit arising from the exemplary embodiments of the present disclosure, as well as other possible embodiments, is that the systems 10, 10a can be configured to identify steerable wheel movers that have failed or are failing, even when no packages are present. Each of the monitored/detected parameters can be compared against a baseline of operation. Alternatively or additionally, the monitored/detected parameters for one steerable wheel mover can be compared against the same the monitored/detected parameters of adjacent steerable wheel movers and/or steerable wheel movers with the same sub-group that are not adjacent. For example, a steerable wheel mover that is producing parameter changes that are different than other steerable wheel movers can be determined to be faulty or failing. By way of example and not limitation, a steerable wheel mover can be determined to be faulty if the difference between its parameter change and the parameter change of other steerable wheel movers is relatively large. By way of example and not limitation, a steerable wheel mover can be determined to be failing if the difference between its parameter change and the parameter change of other steerable wheel movers is not relatively large but is observed repeatedly. The exemplary master controller 28 can be configured to monitor, over time, relative differences in the parameter change of each steerable wheel mover relative to the parameter changes of adjacent steerable wheel movers. This feature can be important for two reasons: first, it can alert of potential replacements needed in the future, but more importantly, it can be used to discount that steerable wheel mover's data input in the determination of mass. If one steerable wheel mover is consistently providing data that is different from the rest then it can be ignored by the exemplary main controller 28. The exemplary main controller 28 could be configured to reduce the weight place on data that it receives from the faulty/failing steerable wheel mover and place more weight on data received from steerable wheel movers that show more consistent results when operating in the same operational condition (package is on top of it), or the data magnitude can be adjusted based on differences in baseline conditions.

What has been described above includes examples of the subject innovation. It is, of course, not possible to describe every conceivable combination of components or methodologies for purposes of describing the disclosed subject matter, but many further combinations and permutations of the subject innovation are possible. The use of any and all examples, or exemplary language (e.g., “such as”) provided herein is intended merely to be illustrative and does not pose a limitation on the scope of any innovation disclosed herein unless otherwise claimed. The word “exemplary” is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. Further, any statements set forth within the Detailed Description of this document and addressing a prior art device(s) are the observations of the inventors and such statements themselves are not prior art or admissions as to what is prior art.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements. Use of the terms “about” or “approximately” are intended to cover values that are above and/or below a stated value or range, or within manufacturing tolerances, as would be understood by one having ordinary skill in the art in the respective context. In some instances, this may encompass values in a range of approx. +/−10%; in other instances there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context. Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein. Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted, unless expressly contradicted by the text herein or context.

While the present disclosure has been described with reference to one or more exemplary embodiments, it is to be understood that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to a particular embodiment disclosed herein as the best mode contemplated for carrying out this present disclosure, but that the present disclosure will be viewed as covering any embodiment falling within the scope of the appended claims. Various aspects or features described herein may be implemented as a method, apparatus, or article of manufacture using standard programming and/or engineering techniques.

Also, the right to claim for patent coverage a particular sub-feature, a sub-component, or a sub-element of any disclosed embodiment, singularly or in one or more sub-combinations with any other sub-feature(s), sub-component(s), or sub-element(s), is hereby unconditionally reserved by the Applicant. Also, particular sub-feature(s), sub-component(s), and sub-element(s) of one embodiment that is disclosed herein can replace particular sub-features, sub-components, and sub-elements of another embodiment disclosed herein or can supplement and be added to another embodiment unless expressly indicated otherwise by the drawings or this specification. The inventors also assert that any of the claims set forth after this detailed description can be combined with any other claim or claims regardless of whether or not there is a direct line of dependency, unless there is an express indication in this text or the drawings unambiguously indicating that such a combination is not possible. The order of the claims and the lines of dependency are irrelevant to the various ways that the features, elements, sub-elements, components, sub-components, etc. of the present disclosure can be combined and thus claimed. Further, the doctrine of claim differentiation is to be applied in construing the appended claims. Further, the use of the word “can” in this document is not an assertion that the subject preceding the word “can” is unimportant or unnecessary or “not critical” relative to anything else in this document. The word “can” is used herein in a positive and affirming sense and no other motive should be presumed. More than one patentable “invention” may be disclosed in the present disclosure and it is noted that an “invention” is defined by the content of a patent claim and not by the content of descriptive text or drawings.

1. A method of operating a conveying system having a plurality of steerable wheel movers mechanically independent with respect to one another and arranged in a plurality of rows comprising:
directing at least one motor of at least one steerable wheel mover of the plurality of steerable wheel movers, with a mover controller of the at least one steerable wheel mover, to rotate a wheel of the at least one steerable wheel mover about a wheel axis of rotation at a first rotational velocity or to rotate the wheel about a steer angle axis that is normal to the wheel axis of rotation to a first angular orientation about the steer angle axis;
detecting a change in at least one operating parameter of the at least one steerable wheel mover after said directing other than the change to the directed rotational velocity of the wheel or to the directed angular orientation of the wheel; and
determining, with a master controller of the conveying system, at least a portion of the mass of a package positioned at least in part on the at least one steerable wheel mover based at least in part on the change detected during said detecting.

2. The method of claim 1 wherein said detecting is further defined as:
detecting the change in the at least one operating parameter chosen from the group comprising a current passing through the at least one motor, a power consumption of the at least one motor, a temperature increase of the at least one motor, a rotational velocity of the wheel different than the directed rotational velocity of the wheel, and an angular orientation of the wheel different than the directed angular orientation of the wheel.

3. The method of claim 1 wherein said detecting is further defined as:
detecting, with at least one sensor that is external to the at least one steerable wheel mover, the change in the at least one operating parameter of the at least one steerable wheel mover resulting at least in part from said directing other than the rotational velocity of the wheel and the angular orientation of the wheel.

4. The method of claim 1 wherein said detecting is further defined as:
detecting, with the mover controller of the at least one steerable wheel mover, the change in the at least one operating parameter of the at least one steerable wheel mover resulting at least in part from said directing other than the rotational velocity of the wheel and the angular orientation of the wheel.

5. The method of claim 1 wherein said directing is further defined as:
directing with a first motor of the at least one motor of the at least one steerable wheel mover of the plurality of steerable wheel movers, with the mover controller of the at least one steerable wheel mover, to rotate the wheel of the at least one steerable wheel mover about the wheel axis of rotation at the first rotational velocity and with a second motor of the at least one motor to rotate the wheel about the steer angle axis that is normal to the wheel axis of rotation to the first angular orientation about the steer angle axis.

6. The method of claim 5 wherein said detecting is further defined as:
detecting the change in the at least one operating parameter of only one of the first motor and the second motor of the at least one steerable wheel mover resulting at least in part from said directing other than the rotational velocity of the wheel and the angular orientation of the wheel.

7. The method of claim 5 wherein said detecting is further defined as:
detecting the change in the at least one operating parameter including a first operating parameter of the first motor and a second operating parameter of the second motor resulting at least in part from said directing other than the rotational velocity of the wheel and the angular orientation of the wheel.

8. The method of claim 1 wherein said detecting is further defined as:
detecting a change in at least one operating parameter in the form of a velocity error defined as the difference between the first rotational velocity and an actual rotational velocity of the wheel about the wheel rotation axis after said directing.

9. The method of claim 8 wherein said determining is further defined as:
determining, with the master controller of the conveying system, the at least a portion of the mass of the package positioned at least in part on the at least one steerable wheel based at least in part on the velocity error.

10. The method of claim 1 wherein said detecting is further defined as:
detecting a change in at least one operating parameter in the form of an angular orientation error defined as the difference between the first angular orientation and an actual angular orientation of the wheel about the steer angle axis after said directing.

11. The method of claim 10 wherein said determining is further defined as:
determining, with the master controller of the conveying system, the at least a portion of the mass of the package positioned at least in part on the at least one steerable wheel based at least in part on the angular orientation error.

12. The method of claim 1 wherein:
said directing is further defined as directing respective at least one motors of a set of steerable wheel movers of the plurality of steerable wheel movers, with respective mover controllers of the set of steerable wheel movers, to rotate respective wheels of the set of steerable wheel movers about respective wheel axes of rotation at the first rotational velocity and to rotate the respective wheels about respective steer angle axes each normal to the respective wheel axes of rotation to the first angular orientation about the respective steer angle axes; and
said detecting is further defined as detecting at least one change in at least one operating parameter of each of the set of steerable wheel movers resulting at least in part from said directing.

13. The method of claim 12 wherein said determining is further defined as determining, with the master controller of the conveying system, the at least a portion of the mass of the package positioned at least in part on the set of steerable wheel movers based at least in part on the changes respectively detected at each of the set of steerable wheel movers during said detecting.

14. The method of claim 12 wherein said determining is further defined as determining, with the master controller of the conveying system, a height of the package positioned at least in part on the set of steerable wheel movers based at least in part on the changes respectively detected at each of the set of steerable wheel movers during said detecting.

15. The method of claim 12 wherein:
said directing is further defined as:
first directing each of the respective at least one motor of a first set of steerable wheel movers of the plurality of steerable wheel movers, with the respective mover controllers of the first set of steerable wheel movers, to rotate the respective wheels of the first set of steerable wheel movers about respective the wheel axes of rotation at the first rotational velocity and to rotate the respective wheels of the first set of steerable wheel movers about respective steer angle axes that are each normal to the respective wheel axis of rotation to the first angular orientation about the respective steer angle axes, and
second directing, after said first directing, each of the respective at least one motor of a second set of steerable wheel movers of the plurality of steerable wheel movers, with the respective mover controllers of the second set of steerable wheel movers, to rotate the respective wheels of the second set of steerable wheel movers about the respective wheel axes of rotation of the second set of steerable wheel movers at a second rotational velocity and to rotate the respective wheels of the second set of steerable wheel movers about the respective steer angle axes of the second set of steerable wheel movers, each normal to the respective wheel axis of rotation, to a second angular orientation about the respective steer angle axes of the second set of steerable wheel movers;
said detecting is further defined as:
first detecting at least one change in at least one operating parameter of each of the first set of steerable wheel movers resulting at least in part from said first directing, and
second detecting, after said first detecting, at least one change in at least one operating parameter of each of the second set of steerable wheel movers resulting at least in part from said second directing; and
said determining is further defined as:
first determining, with the master controller of the conveying system, the at least a portion of the mass of the package positioned on the first set of steerable wheel movers based at least in part on the changes respectively detected at each of the first set of steerable wheels during said first detecting, and
second determining, after said first determining, with the master controller of the conveying system, the at least a portion of the mass of the package positioned on the second set of steerable wheel movers based at least in part on the changes respectively detected at each of the second set of steerable wheels during said second detecting and also based at least in part on the first mass load determined during said first determining.

16. The method of claim 12 wherein:
said directing is further defined as:
first directing each of the respective at least one motor of a first set of steerable wheel movers of the plurality of steerable wheel movers, with the respective mover controllers of the first set of steerable wheel movers, to rotate the respective wheels of the first set of steerable wheel movers about respective the wheel axes of rotation at the first rotational velocity and to rotate the respective wheels of the first set of steerable wheel movers about respective steer angle axes that are each normal to the respective wheel axis of rotation to the first angular orientation about the respective steer angle axes, and
second directing, after said first directing, each of the respective at least one motor of a second set of steerable wheel movers of the plurality of steerable wheel movers, with the respective mover controllers of the second set of steerable wheel movers, to rotate the respective wheels of the second set of steerable wheel movers about the respective wheel axes of rotation of the second set of steerable wheel movers at a second rotational velocity and to rotate the respective wheels of the second set of steerable wheel movers about the respective steer angle axes of the second set of steerable wheel movers, each normal to the respective wheel axis of rotation, to a second angular orientation about the respective steer angle axes of the second set of steerable wheel movers;
said detecting is further defined as:
first detecting at least one change in at least one operating parameter of each of the first set of steerable wheel movers resulting at least in part from said first directing, and
second detecting, after said first detecting, at least one change in at least one operating parameter of each of the second set of steerable wheel movers resulting at least in part from said second directing; and
said determining further comprises:
first determining, with the master controller of the conveying system, a first height of the package positioned on the first set of steerable wheel movers based at least in part on the changes respectively detected at each of the first set of steerable wheels during said first detecting, and
second determining, after said first determining, with the master controller of the conveying system, a second height of the package positioned on the second set of steerable wheel movers based at least in part on the changes respectively detected at each of the second set of steerable wheels during said second detecting and also based at least in part on the first height determined by said first determining.

17. The method of claim 12 further comprising:
comparing, with the master controller, the at least one change in the at least one operating parameter of a first steerable wheel mover of the set of steerable wheel movers of the plurality of steerable wheel movers against the at least one change in the at least one operating parameter of a second steerable wheel mover of the set of steerable wheel movers of the plurality of steerable wheel movers.

18. The method of claim 1 further comprising:
determining, with the master controller of the conveying system, the first angular orientation about the steer angle axis based at least in part on a second mass load of the package received by the master controller before said directing.

19. The method of claim 1 wherein said detecting is further defined as:
detecting a change in at least one operating parameter of the at least one steerable wheel mover after said directing and after the directed rotational velocity of the wheel or the directed angular orientation of the wheel has been reached.

20. The method of claim 1 wherein said detecting is further defined as:
detecting a change in at least one operating parameter of the at least one steerable wheel mover after said directing and after the directed rotational velocity of the wheel or to the directed angular orientation of the wheel has been reached and substantially immediately after the wheel has engaged a package has moved into a position at least in part on the at least one steerable wheel mover.

21. A conveying system comprising:
a plurality of steerable wheel movers mechanically independent with respect to one another and arranged in a plurality of rows;
a plurality of sub-controllers, each disposed in communication with more than one of said plurality of steerable wheel movers; and
a master controller disposed in communication with all of said plurality of sub-controllers; and
wherein:
each of said plurality of steerable wheel movers is configured to move packages, wherein each includes a mover controller and at least one motor and a wheel, wherein each of said mover controllers is configured to direct the respective said at least one motor to rotate said respective wheel about a wheel axis of rotation at a first rotational velocity and to rotate said respective wheel about a steer angle axis normal to said wheel axis of rotation to a first angular orientation about said steer angle axis, and each of said respective mover controllers is configured to detect a change in at least one operating parameter of each of said plurality of steerable wheel movers resulting at least in part from the directing of said at least one motor other than the rotational velocity of the wheel and the angular orientation of the wheel; and
said master controller is configured to determine at least part of a mass a package positioned at least in part on at least one steerable wheel mover based at least in part on the detected change.

22. The conveying system of claim 21 wherein, for each of said plurality of steerable wheel movers, said respective at least one motor is further defined as a respective first motor configured to rotate said respective wheel about said respective wheel axis of rotation and a respective second motor configured to rotate said respective wheel about said respective steer angle axis.
